(19) United States
(12) Patent Application Publication
(10) Pub. No.: US 2007/0055923 A1
(43) Pub. Date: Mar. 8, 2007

(54) Xforms processing of large data sets

(75) Inventors: Jeffrey T. Calow, Westford, MA (US); Derek W. Carr, Cary, NC (US); Ronny A. Pena, Lowell, MA (US); Mark E. Wallace, Dublin (IE); Ajamu A. Wesley, Marlborough, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/221,631

(22) Filed: Sep. 8, 2005

(51) Int. Cl. G06F 17/00

(52) U.S. Cl. 715/505

(57) ABSTRACT

Embodiments of the present invention provide a method, system and computer program product for processing large data sets in a forms-based application. In one embodiment of the invention, a data processing system configured for forms based application processing of large data sets can include a repeat directive disposed within form markup for the forms-based application. The system further can include one or more repeating items logically coupled to the repeat directive in the form markup for a data set in a forms instance in the form markup. Finally, the system can include a dynamic binding for a user interface control in the form markup to an indexed one of the repeating items specified by the repeat directive. Optionally, the system further can include a prototype for the repeating items disposed in the repeat directive, the prototype defining default values for fields in the repeating items.

### BACKGROUND OF THE INVENTION

1. Field of the Invention

The present invention relates to the field of forms processing in a data driven system and more particularly to processing large data sets in a forms based data driven system.

2. Description of the Related Art

Form based input is the enabling technology which permits the widespread distribution of applications across generic client platforms such as the conventional content browser. In the prototypical distributed application, a markup language defined interface can form the principal conduit through which end users can interact with backend application logic. Often configured in the form of a Web page, the interface can be provided to the content browser by a content server and can take the form either of a pre-defined static page, or a dynamically generated page. Form input fields can be positioned within the interface through which user input can be accepted and posted to the backend application logic for further processing.

Despite the flexibility afforded by hypertext markup language (HTML) defined forms, HTML defined forms mix data, logic and presentation in contravention of standard programming practices. In this regard, the well-known model-view-controller paradigm demands that each of data, logic presentation remain separable. In this way, though the presentation layer may change to suit the user interface requirements of an end user, the underlying logic layer need not also change. To accommodate the increasing complexity of transactions conducted through forms, the XForms specification has been proposed as a presentation independent way of handling interactive Web transactions. Significantly, the XForms specification separates data and logic from presentation in that XForms utilizes the extensible markup language (XML) for data transport and HTML for data display.

In XForms, user interface controls for a forms based application can be bound to XML instance data using XPath expressions, as is well known in the art. For repeating instances of data in an XML data set, XForms defines a repeat module which includes a repeat element. The repeat element defines a user interface mapping over a homogeneous collection selected by node set binding attributes. The use of the repeat module has been found to be quite efficient when addressing small data sets such as the item contents of an electronic shopping cart. Forms based applications can be applied to structured data sets; however, large data sets provide a unique challenge relative to XForms.

Specifically, substantial processing and resources overhead can be consumed in processing XForms in conjunction with large data sets. Large data sets often are encountered when processing repeating data sets such as entries in a syndicated content feed. Notably, while the XForms standard supports repeating data sets, XForms defers the implementation of the processing model for repeating data sets to vendors and fails to provide guidance in addressing the issue of large data sets.

### BRIEF SUMMARY OF THE INVENTION

Embodiments of the present invention address deficiencies of the art in respect to forms based processing of large data sets and provide a novel and non-obvious method, system and computer program product for processing large data sets in a forms-based application.

In one embodiment of the invention, a data processing system configured for forms based application processing of large data sets can include a repeat directive disposed within form markup for the forms-based application. The data processing system further can include one or more repeating items logically coupled to the repeat directive in the form markup for a data set in a forms instance in the form markup. Finally, the data processing system can include a dynamic binding for a user interface control in the form markup to an indexed one of the repeating items specified by the repeat directive. Optionally, the system further can include a prototype for the repeating items disposed in the repeat directive, the prototype defining default values for fields in the repeating items.

In another embodiment of the invention, a method for processing large data sets in a forms-based application can include defining a schema for a large data set in a content repository, generating a repeat element linking an item in an instance of the schema, and dynamically binding a user interface control for the forms-based application to a dynamic index of the item linked in the repeat element. The method further can include generating a separate prototype instance for the item linked in the repeat element, specifying a default value for a field in the prototype instance, and referencing the separate prototype in the repeat element. The method yet further can include inserting a new item based upon the item linked in the repeat element, and assigning the default value to a field in the new item corresponding to the field in the prototype instance.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured for forms based processing of large data sets; and,

FIG. 2 is a block diagram illustrating a method for processing large data sets in a forms based application.

### DETAILED DESCRIPTION OF THE INVENTION

Embodiments of the present invention provide a method, system and computer program product for processing large data sets in a forms-based application. In accordance with an embodiment of the present invention, a repeat directive disposed within form markup. The repeat directive can be logically coupled to a repeating item in the form markup for a data set in a forms instance in the form markup and dynamically bound to an indexed data item specified by a user interface control binding in the form markup. Optionally, a prototype for the field can be established in a separate instance in the form markup and the separate instance can be referenced from within the repeat directive for the form markup.

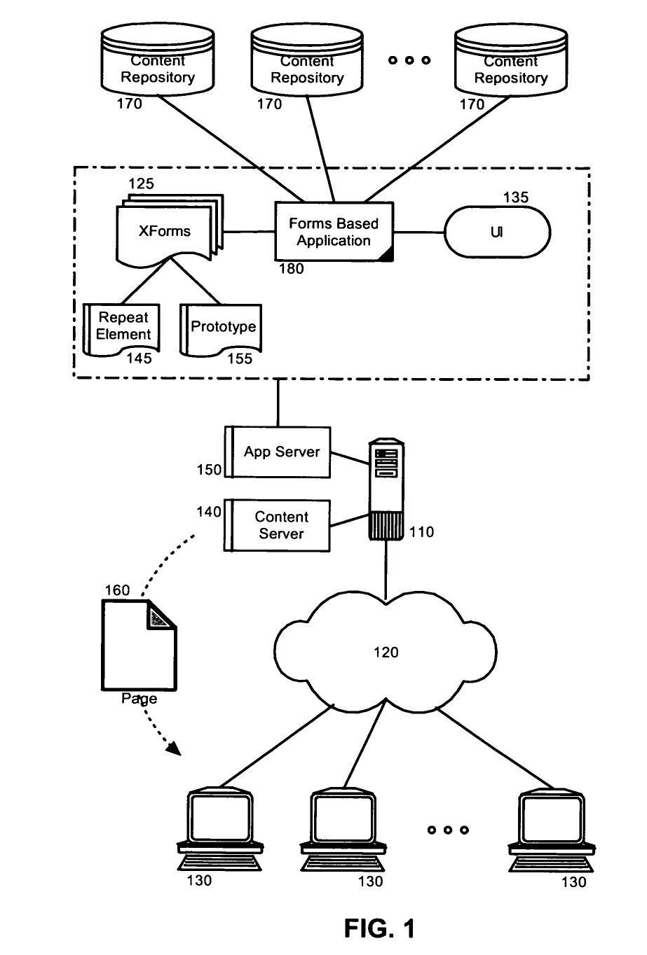

In more particular illustration, FIG. 1 is a schematic illustration of a data processing system configured for forms based processing of large data sets. The data processing system can include a host computing platform 110 coupled to one or more client computing platforms 130 over a data communications network 120. The host computing platform 110 can include a content server 140 and an application server 150 operable coupled to one another to provide a forms based application 180 and a user interface 135 to the forms based application 180 to end users interacting with the forms based application 180 through the client computing platforms 130.

The forms based application 180 can be coupled to one or more data sets across one or more disparate content repositories 170. In this regard, the forms based application 180 can include a binding of user interface elements within the user interface 135 to one or more data items in the content repositories 170 defined by a schema within one or more XForms directives 125 for the forms based application 180. At least one the XForms directives 125 can be configured to generate and bind at least one user interface element for each of a repeating set of items for a schema for a data set in the repositories 170.

Specifically, a repeat element 145 can include included in an XForms directive 125 to identify the repeating set of items. Unlike the static binding to a data item of a conventional repeat element, the repeat element 145 can include a dynamic binding to a designated field within a currently indexed data item. In this regard, whereas a static mapping of a conventional repeat directive addresses the data item by static index, as shown in FIG. 1, the repeat element 145 can dynamically map to a data item using an indexed XPath expression. Moreover, to facilitate the insertion of an additional data item, a prototype instance 155 for the data item having default values can be referenced within the repeat element 145. In this way, when the new data item is created, the default values of the prototype instance 155 can be applied to the inserted data item.

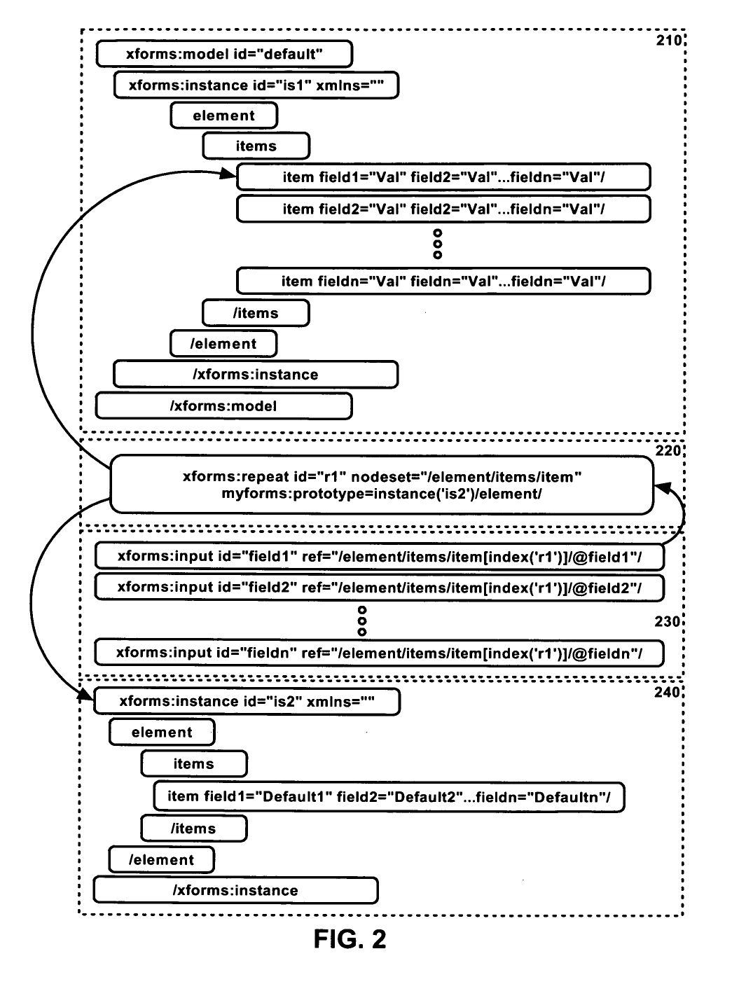

In further illustration, FIG. 2 is a block diagram illustrating a method for processing large data sets in a forms based application. As shown in FIG. 2, a schema 210 can define one or more data items in a form instance. A repeat element 220 can bind a specified data item to a repeat identifier. The repeat element 220 also can include a reference to a prototype instance 240. Conversely, one or more user interface element bindings 230 can reference the repeat element 220 using a dynamic reference to a current index for repeated ones of the data items. Finally, the prototype instance 220 can specify default values for the fields of the data item in the schema 210. In this way as new data items are inserted in sequence, the default values of the prototype instance 240 can be used to populate the values of the added data item.

In operation, instance data can be specified in the schema 210. Also, the repeat element 220 can be defined and bound to repeating data items in the instance of the schema 220, for instance using a dynamic XPath expression. Likewise, user interface controls can be bound to the instance data using a dynamic XPath expression in the user interface element bindings 230. Thereafter, to iterate over the instance data, the setIndex method known in the XForms art can be used, while values for fields in inserted data items can be applied according to the default values of the prototype instance 240 referenced by the repeat element 220.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A data processing system for processing large data sets in a forms-based application comprising:
a repeat directive disposed within form markup for the forms-based application;
a plurality of repeating items logically coupled to said repeat directive in said form markup for a data set in a forms instance in said form markup; and,
a dynamic binding for a user interface control in said form markup to an indexed one of said repeating items specified by said repeat directive.

2. The data processing system of claim 1, further comprising a prototype for said repeating items disposed in said repeat directive, said prototype defining default values for fields in said repeating items.

3. The data processing system of claim 1, wherein said form markup is XForms compliant.

4. A method for processing large data sets in a forms-based application comprising:
defining a schema for a large data set in a content repository;
generating a repeat element linking an item in an instance of said schema; and,
dynamically binding a user interface control for the forms-based application to a dynamic index of said item linked in said repeat element.

5. The method of claim 4, further comprising:
generating a separate prototype instance for said item linked in said repeat element;
specifying a default value for a field in said prototype instance; and,
referencing said separate prototype in said repeat element.

6. The method of claim 5, further comprising:
inserting a new item based upon said item linked in said repeat element; and,
assigning said default value to a field in said new item corresponding to said field in said prototype instance.

7. The method of claim 4, wherein defining a schema for a large data set in a content repository comprises defining an XForms schema for a large data set in a content repository.

8. The method of claim 4, wherein dynamically binding a user interface control for the forms-based application to a dynamic index of said item linked in said repeat element comprises generating an XPath expression to reference an item of a variable index according to said repeat element.

9. A computer program product comprising a computer usable medium having computer usable program code for processing large data sets in a forms-based application, said computer program product including:
computer usable program code for defining a schema for a large data set in a content repository;
computer usable program code for generating a repeat element linking an item in an instance of said schema; and,
computer usable program code for dynamically binding a user interface control for the forms-based application to a dynamic index of said item linked in said repeat element.

10. The computer program product of claim 9, further comprising:
computer usable program code for generating a separate prototype instance for said item linked in said repeat element;
computer usable program code for specifying a default value for a field in said prototype instance; and,
computer usable program code for referencing said separate prototype in said repeat element.

11. The computer program product of claim 10, further comprising:
computer usable program code for inserting a new item based upon said item linked in said repeat element; and,
computer usable program code for assigning said default value to a field in said new item corresponding to said field in said prototype instance.

12. The computer program product of claim 9, wherein said computer usable program code for defining a schema for a large data set in a content repository, comprises computer usable program code for defining an XForms schema for a large data set in a content repository.

13. The computer program product of claim 9, wherein said computer usable program code for dynamically binding a user interface control for the forms-based application to a dynamic index of said item linked in said repeat element, comprises computer usable program code for generating an XPath expression to reference an item of a variable index according to said repeat element.
